(19) United States
(12) Patent Application Publication
(10) Pub. No.: US 2020/0302717 A1
(43) Pub. Date: Sep. 24, 2020

(54) METHOD FOR OPERATING ELECTRONIC LOCK

(71) Applicant: POWERTEK HARDWARE CO., LTD., TAICHUNG (TW)

(72) Inventor: Chung-Yu CHEN, TAICHUNG (TW)

(21) Appl. No.: 16/380,674

(22) Filed: Apr. 10, 2019

(30) Foreign Application Priority Data
Mar. 20, 2019 (TW) 108109564

(51) Int. Cl. G07C 9/00; G06F 16/25

(52) U.S. Cl. CPC G07C 9/00309; G07C 2009/00317; G07C 2009/00769; G06F 16/252

(57) ABSTRACT

A method for operating an electronic lock system is implemented between an electronic lock and a portable device. A user must first input an unlocking command to the electronic lock, and the electronic lock determines whether the unlocking command is correct. If yes, the electronic lock further performs short-range communication with the portable device and determines whether the portable device is registered. If yes, the electronic lock will be unlocked. The user only needs to perform a single unlocking operation, and the electronic lock determines whether to unlock through double verification, which combines ease of operation and safety.

### FIELD OF THE INVENTION

The present invention relates to a method for operating an electronic lock, and more particularly to a method that combines ease of operation and safety for operating an electronic lock.

### BACKGROUND OF THE INVENTION

The existing electronic lock operation methods can be classified into a touch means and an inductive means. The touch means is to input a password, that is, the electronic lock is provided with a keypad for the user to input a preset password. If the password is correct, the electronic lock will be unlocked. The inductive means is the most popular means for a mobile phone to be unlocked. A wireless sensing module, such as Bluetooth, is disposed in the electronic lock. The user can carry the mobile phone to approach the electronic lock, and the electronic lock communicates with the mobile phone through the wireless sensing module to obtain the identity data of the mobile phone. When the user presses the opening button of the electronic lock, it is determined whether the mobile phone is registered, and if yes, the electronic lock will be unlocked.

However, the above-mentioned electronic lock can be unlocked by a single unlocking operation, no matter what means is adopted, the touch means or inductive means. Anyone who just gets the user's password or mobile phone can unlock the electronic lock at will, so the security is not enough. On the other hand, although the user can increase the number of unlocking operations to improve security, for example, two passwords need to be input, but in this manner, the user needs to perform multiple unlocking operations to unlock the electronic lock. It is inconvenient for operation.

Although the foregoing means for unlocking a mobile phone is convenient for operation, the opening button of the electronic lock is fixed and obvious. When the user unlocks the electronic lock and enters the house, any person immediately presses the opening button again, the electronic lock will be unlocked, and the stalker may enter the house. For this shortcoming, the existing electronic locks have several solutions. One is to increase the antenna to determine whether the mobile phone is inside or outside the door, but this means will increase the cost and installation difficulty of the electronic lock. The other is to increase a security mechanism. For example, the electronic lock can be unlocked again after the mobile phone is far away from the detection range, but this means has new problems. If the user accidentally leaves the mobile phone near the electronic lock after entering the house, other family members will not be able to unlock the electronic lock to enter the house. Accordingly, the inventor of the present invention has devoted himself based on his many years of practical experiences to solve these problems.

### SUMMARY OF THE INVENTION

The primary object of the present invention is to provide a method for operating an electronic lock. The user only needs to perform a single unlocking operation, and the electronic lock determines whether to unlock through double verification, which combines ease of operation and safety. It can solve the shortcomings of the conventional inductive unlocking.

In order to achieve the above object, the present invention provides a method for operating an electronic lock system, implemented between an electronic lock and a portable device. The electronic lock has a lock body. The lock body is provided with a control module. The control module is connected to an input module and a first short-distance communication module. The first short-distance communication module is in a closed state when the lock body is locked. The portable device is provided with a second short-distance communication module. The second short-distance communication module is in an open state. The method comprises the following steps: when the lock body is locked, a user carrying a portable device to approach the electronic lock, and an unlocking command being input through an input module; the control module determining whether the unlocking command is correct, if yes, the first short-distance communication module being activated; the first short-distance communication module being wirelessly connected to the second short-distance communication module for short-distance communication to obtain identity data of the portable device; the control module determining whether the portable device is registered according to the identity data, if yes, the lock body being controlled to unlock.

The user only needs to carry the portable device to approach the electronic lock and input the unlocking command, and the electronic lock determines whether to unlock by determining whether the unlocking command is correct and by determining whether the portable device is registered or not. Double verification can improve security, which combines ease of operation and safety. Since the correct unlocking command must be input, the electronic lock can further activate the communication between the first short-distance communication module and the portable device, so that the stalker can be prevented from entering the house effectively.

### BRIEF DESCRIPTION OF THE DRAWINGS

FIG. 1 is a schematic view of the electronic lock system in accordance with a preferred embodiment of the present invention;

FIG. 2 is a block diagram of the electronic lock system in accordance with the preferred embodiment of the present invention;

FIG. 3 is a schematic view of an implementation of the input module in accordance with the preferred embodiment of the present invention;

FIG. 4 is a schematic view of another implementation of the input module in accordance with the preferred embodiment of the present invention;

FIG. 5 is a block diagram of the preferred embodiment of the present invention;

FIG. 6 is a schematic view of the preferred embodiment of the present invention when in use; and

FIG. 7 is a schematic view showing the use of the input module of the preferred embodiment of the present invention.

### DETAILED DESCRIPTION OF THE PREFERRED EMBODIMENTS

Embodiments of the present invention will now be described, by way of example only, with reference to the accompanying drawings.

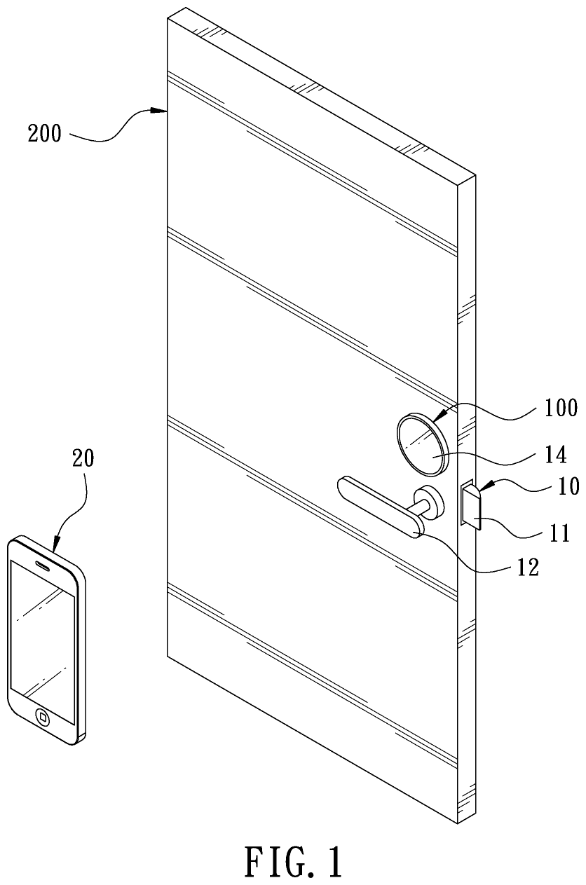

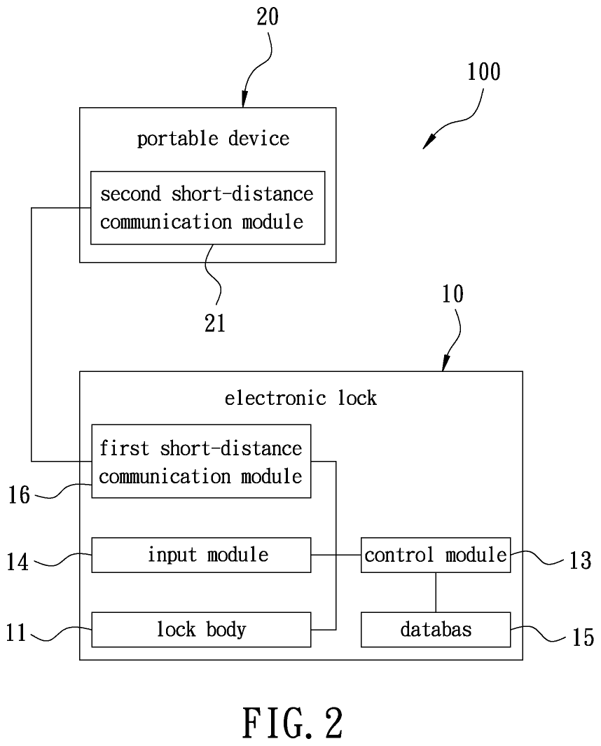

FIG. 1 is a schematic view of an electronic lock system in accordance with a preferred embodiment of the present invention. FIG. 2 is a block diagram of the electronic lock system in accordance with the preferred embodiment of the present invention. The present invention discloses an electronic lock system 100. The electronic lock system 100 comprises an electronic lock 10 and a portable device 20.

The electronic lock 10 is configured to be mounted on a door body 200. The electronic lock 10 has a lock body 11. The lock body 11 is connected with a handle 12 and a control module 13 for driving the lock body 11 to be locked and unlocked. As to the locking and unlocking means, an electric motor or the like may be used for driving the electronic lock 10, which is the prior art and won't be described hereinafter. The control module 13 is further connected to an input module 14 for the user to input an unlocking command. The control module 13 is further connected to a database 15 for the user to pre-register the unlocking command and register the portable device 20. The control module 13 is further connected to a first short-distance communication module 16. The first short-distance communication module 16 is in a closed state when the lock body 11 is locked. In this embodiment, the first short-distance communication module 16 is a Bluetooth interface.

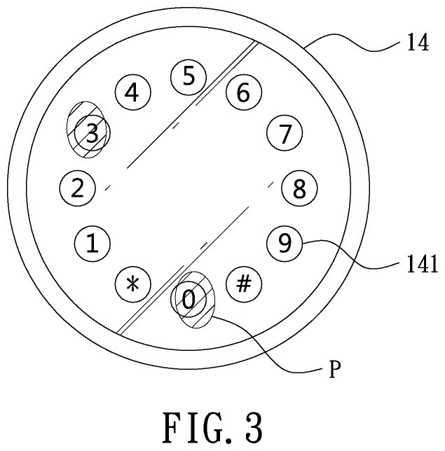

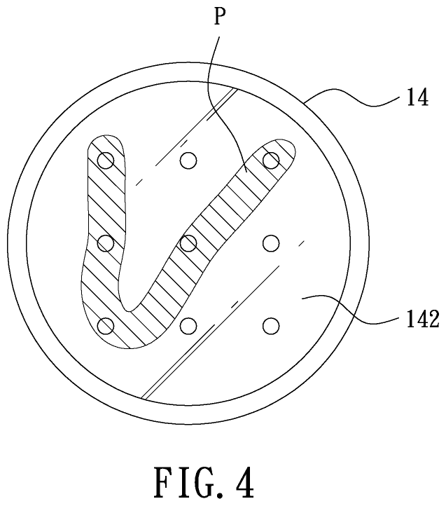

FIG. 3 is a schematic view of an implementation of the input module in accordance with the preferred embodiment of the present invention. FIG. 4 is a schematic view of another implementation of the input module in accordance with the preferred embodiment of the present invention. The input module 14 can be a physical keypad or the like. Preferably, the input module 14 is a touch screen as shown in this embodiment for the user to input the unlocking command by a touch means P. The touch screen is in a sleep state without displaying any information, and the user can wake it up by touching or tapping. After the touch screen is awakened, as shown in FIG. 3, the touch screen displays a plurality of virtual buttons 141. The virtual buttons 141 may be one of a letter, a number, a pattern or a sign. The unlocking command is a password. The password is one of the letter, number, figure and sign or a combination thereof. Preferably, it is designed to change the position of the virtual buttons 141 every time when the touch screen is awakened to prevent the password from being guessed correctly due to residual fingerprints. In another implementation, as shown in FIG. 4, the touch screen displays a drawing area 142, and the unlocking command is a pattern.

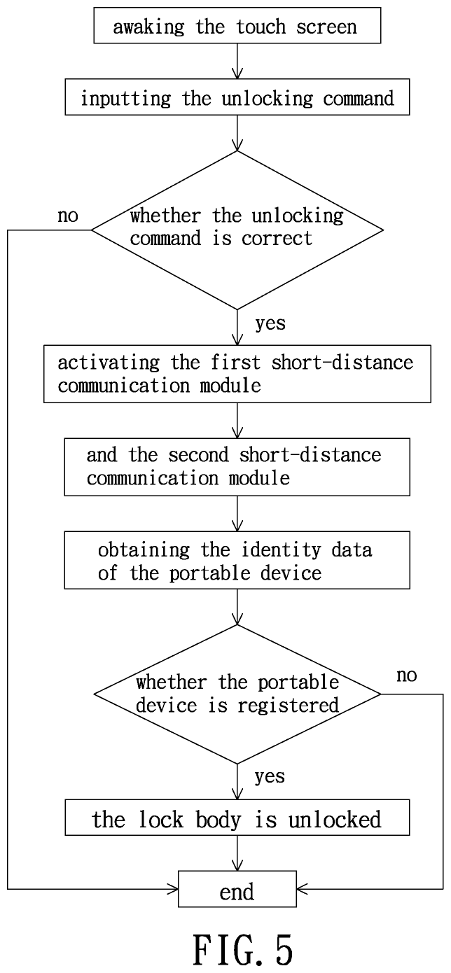

FIG. 5 is a block diagram of the preferred embodiment of the present invention. The present invention discloses a method for operating the electronic lock system 100. The method comprises the following steps:

When the lock body 11 is locked, the user carries the portable device 20 to approach the electronic lock 10, and the unlocking command is input through the input module 14.

After the user inputs the unlocking command, the control module 13 determines whether the unlocking command is correct. If yes, the first short-distance communication module 16 is activated. Wherein, the control module 13 can determine whether the unlocking command is correct by comparing it with the database 15.

The first short-distance communication module 16 is wirelessly connected to a second short-distance communication module 21 for short-distance communication to obtain the identity data of the portable device 20. In this embodiment, the identity data of the portable device 20 is obtained by means of Bluetooth communication.

The control module 13 determines whether the portable device 20 is registered according to the identity data. If yes, the lock body 11 being controlled to unlock. Wherein, the control module 13 can determine whether the portable device 20 is registered by comparing it with the database 15.

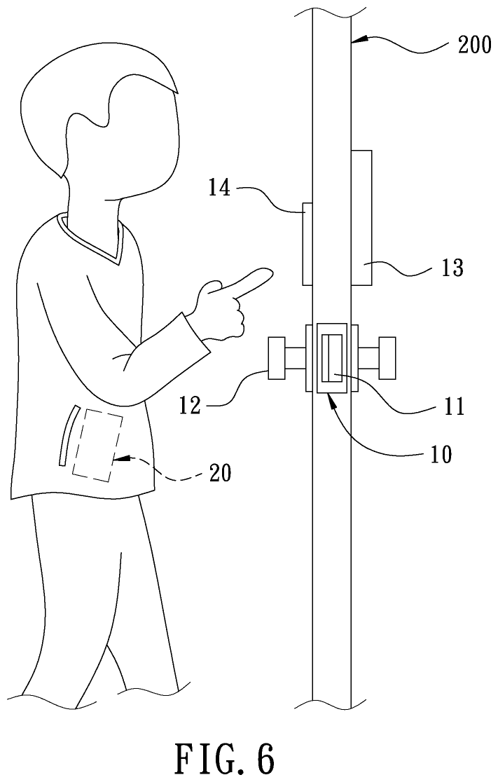

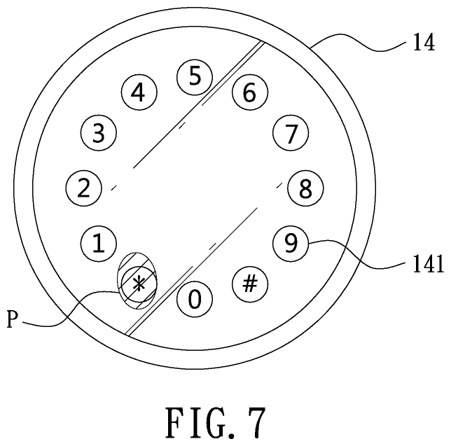

FIG. 6 and FIG. 7 are schematic views of the preferred embodiment of the present invention when in use. Before use, the user needs to set the unlocking command and register the portable device 20. For example, the user may set the “*” button as the unlocking command and register the portable device 20 by Bluetooth pairing. In operation, the user only needs to carry the portable device 20 to approach the electronic lock 10, as shown in FIG. 6. Then, the input module 14 is awakened, as shown in FIG. 7, and the “*” button is pressed. The control module 13 activates the first short-distance communication module 16 and verifies whether the portable device 20 is registered by means of wireless short-distance communication. If the portable device 20 is registered, the lock body 11 is unlocked, thereby allowing the user to perform a single unlocking operation. Double verification can improve security, which combines ease of operation and safety.

It is worth mentioning that since the double verification has been adopted to improve the security, the user can use a simple password as the unlocking command as described above to achieve the quick unlocking effect same as the conventional mobile phone.

It is worth mentioning that since the user has to input the correct unlocking command, the control module 13 activates the first short-distance communication module 16 to verify whether the portable device 20 is registered. Therefore, the power consumption of the electronic lock 10 can be reduced, and the stalker can be prevented from entering the house effectively.

Although particular embodiments of the present invention have been described in detail for purposes of illustration, various modifications and enhancements may be made without departing from the spirit and scope of the present invention. Accordingly, the present invention is not to be limited except as by the appended claims.

1. A method for operating an electronic lock system,
implemented between an electronic lock and a portable device, the electronic lock having a lock body, the lock body being provided with a control module, the control module being connected to an input module and a first short-distance communication module, the first short-distance communication module being in a closed state when the lock body is locked, the portable device being provided with a second short-distance communication module, the second short-distance communication module being in an open state, the method comprising the following steps for each unlocking operation:
when a user carrying the portable device approaches the electronic lock with the lock body locked, the user inputting an unlocking command through the input module;
the control module determining whether the unlocking command is correct, if yes, the first short-distance communication module being wirelessly connected to the second short-distance communication module for short-distance communication to obtain identity data of the portable device; and
the control module determining whether the portable device is registered according to the identity data, if yes, the lock body being controlled to unlock.

2. The method as claimed in claim 1, wherein the input module is a touch screen for the user to input the unlocking command by touch.

3. The method as claimed in claim 2, wherein the touch screen displays a plurality of virtual buttons, each of the virtual buttons being formed of one or more of a letter, a number, a pattern and a sign, and the unlocking command is a password formed of one or more of the letter, number, figure pattern and sign.

4. The method as claimed in claim 2, wherein the touch screen displays a drawing area, and the unlocking command is a pattern.

5. The method as claimed in claim 1, wherein the control module is connected to a database, and the control module determines whether the unlocking command is correct by comparing it with the database.

6. The method as claimed in claim 1, wherein the control module is connected to a database, and the control module determines whether the portable device is registered by comparing it with the database.

7. The method as claimed in claim 1, wherein the first short-distance communication module and the second short-distance communication module are Bluetooth interfaces.

8. The method as claimed in claim 1, wherein the portable device is a smart phone.
